(19) United States
(12) Patent Application Publication
(10) Pub. No.: US 2025/0251619 A1
(43) Pub. Date: Aug. 7, 2025

(54) CONTACT LENS ASSEMBLIES AND METHODS OF MANUFACTURE THEREOF

(71) Applicant: CooperVision International Limited, Fareham (GB)

(72) Inventor: Robert OAG, Southampton (GB)

(73) Assignee: CooperVision International Limited, Fareham (GB)

(21) Appl. No.: 19/043,548

(22) Filed: Feb. 3, 2025

(30) Foreign Application Priority Data
Feb. 5, 2024 (GB) 2401481.3

(51) Int. Cl. G02C 7/04; B29D 11/00; G02B 1/04

(52) U.S. Cl. CPC G02C 7/049; B29D 11/00038; G02B 1/043; G02C 2202/16; G02C 2202/20

(57) ABSTRACT

A contact lens assembly 100 is disclosed. The contact lens assembly 100 comprises a second lens member 104 located between first and third lens members 102, 106. A structured anterior surface region 110 of the first lens member 102 that defines a diffractive optical element and a posterior surface region 115A of the second lens member 104 together define a first cavity. A structured posterior surface region 112 of the third lens member 106 that defines a diffractive optical element and an anterior surface region 113A of the second lens member 104 together define a second cavity. The posterior and anterior surface regions 115A, 113A of the second lens member 104 do not include a diffractive optical element.

This application claims the benefit of prior United Kingdom Patent Application No. 2401481.3, filed Feb. 5, 2024, which is incorporated in its entirety by reference herein.

The present disclosure concerns contact lens assemblies, more particularly, but not exclusively, contact lens assemblies comprising diffractive optical elements, liquid crystal layers, liquid crystal cells and electronics associated with liquid crystal cells.

### BACKGROUND

An example structure for a liquid crystal cell in a contact lens includes the following layers, in order: a first electrode layer (e.g. having a first polarity), a first insulation layer (for electrically isolating an electrode layer from other layers), a first liquid crystal alignment layer, a liquid crystal layer, a second liquid crystal alignment layer, a second insulation layer and a second electrode layer (e.g. having a second, opposite, polarity, to the first electrode layer). Such a liquid crystal cell may be combined with a diffractive optical element. The liquid crystal cells can then be switched between a first state in which the refractive indices of the first diffractive optical element and the first liquid crystal layer are similar such that the diffractive optical element does not diffract incident light and a second state in which the refractive indices are dissimilar such that the diffractive optical element diffracts incident light, for example such that the diffractive optical element contributes to the optical power of the lens. Examples of such switchable liquid crystal cells are discussed in US 2023/0119885 the contents of which are incorporated herein by reference.

Economic commercial scale manufacture of such lenses is not straightforward due to the need to maintain the various elements of each cell in alignment with each other, and the diffractive optical element. Additionally or alternatively, it is necessary to contain various fluid elements in order to allow the lens to function as intended. For example, adhesives may be used to bond various elements of the assembly together but flow of adhesive into an optical zone of the assembly may adversely affect optical performance. Similarly, flow of fluid from the liquid crystal layer into an adhesive zone of the assembly may cause structural defects and/or cause bubbles to form in the optical zone due to the loss of fluid. It is also necessary to isolate the electrode layers of the liquid crystal cell from any conductive materials that might cause a short circuit in use.

The manufacturing picture is complicated yet further when more than one liquid crystal cell and associated diffractive optical element is to be included in a lens, and particularly when one cell is located in front of the other along an optical axis of the lens. In that case, not only must the elements of each cell be carefully aligned with each other, but they must also be carefully aligned with the elements of the other cell, if the desired optical effect is to be obtained. Furthermore, the inclusion of a second or further liquid crystal cell gives rise to the need to include a second control circuit associated with said cell in the lens, further increasing the risk of a short circuit.

While the above issues are discussed in the context of lenses including liquid crystal cells, it will be appreciated that the issues are not necessarily confined to such lenses and may also arise in other types of lenses in which diffractive optical elements, fluid elements including adhesives and/or electronics are required.

The present disclosure seeks to mitigate or overcome at least one of the above-mentioned problems. Alternatively or additionally, the present disclosure seeks to provide improved apparatus and/or methods for use in machining ophthalmic lenses.

### SUMMARY

In an aspect, the present disclosure provides a contact lens assembly comprising: a first lens member, a second lens member having a structured posterior surface region defining a first diffractive optical element and a structured anterior surface region defining a second diffractive optical element, and a third lens member; wherein the second lens member is located between the first and third lens members such that the structured posterior surface region of the second lens member and an anterior surface region of the first lens member together define a first cavity, and the structured anterior surface region of the second lens member and a posterior surface region of the third lens member together define a second cavity; and wherein the anterior surface region of the first lens member and the posterior surface region of the third lens member do not include a diffractive optical element.

In another aspect, the present disclosure provides a method of constructing a contact lens assembly comprising first, second and third lens members, the method comprising the steps of: forming a first diffractive optical element in a posterior surface of the second lens member and forming a second diffractive optical element in an anterior surface of the second lens member; and then arranging the second lens member between the first and third lens members such that the structured posterior surface region of the second lens member and an anterior surface region of the first lens member together define a first cavity, and the structured anterior surface region of the second lens member and a posterior surface region of the third lens member together define a second cavity; and wherein the posterior surface region of the third lens member and the anterior surface region of the first lens member do not include a structured surface region defining a diffractive optical element.

In another aspect, the present disclosure provides a contact lens comprising the contact lens assembly according to any other aspect.

In another aspect, the present disclosure provides, a blister package containing a contact lens according to the above aspect.

Optional but preferred features are set out in the dependent claims.

It will of course be appreciated that features described in relation to one aspect of the present disclosure may be incorporated into other aspects of the present disclosure. For example, methods of the disclosure may incorporate any of the features described with reference to the apparatus of the disclosure and vice versa.

### DESCRIPTION OF THE DRAWINGS

Example embodiments will now be described, by way of example only, with reference to the accompanying schematic drawings, of which:

FIG. 1 is a cross-sectional view of a contact lens assembly according to an example embodiment of the present disclosure.

FIG. 2 is a cross-sectional view of an example liquid crystal layer according to an example embodiment of the present disclosure.

FIG. 3 is a cross-sectional view of part of a contact lens assembly according to an embodiment of the present disclosure.

FIG. 4 is an enlarged view of a region of FIG. 3.

FIG. 5 shows the lens assembly of FIGS. 3 and 4 on the left-hand side, and another lens assembly according to an example embodiment of the present disclosure on the right-hand side.

FIG. 6A shows a cross-sectional view of an inner region of the single stack contact lens assembly of FIG. 5.

FIG. 6B shows a cross-section view of an inner region of the double stack contact lens assembly of FIG. 5.

FIG. 6C shows a peripheral region of the contact lens assembly of FIG. 6A.

FIG. 6D shows a peripheral region of the contact lens assembly of FIG. 6B.

FIG. 7 is a cross-sectional view of part of a contact lens assembly according to an embodiment of the present disclosure.

FIG. 8 shows the steps of an example method in accordance with the present disclosure.

FIG. 9 shows the steps of another example method in accordance with the present disclosure.

FIG. 10 shows the steps of another example method in accordance with the present disclosure.

### DETAILED DESCRIPTION

According to a first aspect of the present disclosure, there is provided a contact lens assembly comprising one or more of the following: a first lens member having a structured anterior surface region defining a first diffractive optical element; a second lens member; and a third lens member having a structured posterior surface region defining a second diffractive optical element. It may be that the second lens member is located between the first and third lens members such that the structured anterior surface region of the first lens member and a posterior surface region of the second lens member together define a first cavity and/or the structured posterior surface region of the third lens member and an anterior surface region of the second lens member together define a second cavity. It may be that the posterior and anterior surface regions of the second lens member do not include a diffractive optical element.

Thus, neither of the surfaces defining the diffractive optical elements are on the second lens member. Providing a second lens member that does not include the diffractive optical elements may increase the degree to which the second lens member can be misaligned relative to the first and third lens members during manufacture without adversely affecting optical performance, and may thereby make manufacture easier and/or reduce the risk of lens assemblies being rejected during manufacture.

Alternatively, it may be that the contact lens assembly comprises one or more of a first lens member, a second lens member having a structured posterior surface region defining a first diffractive optical element and a structured anterior surface region defining a second diffractive optical element, and a third lens member. It may be that the second lens member is located between the first and third lens members such that the structured posterior surface region of the second lens member and an anterior surface region of the first lens member together define a first cavity, and the structured anterior surface region of the second lens member and a posterior surface region of the third lens member together define a second cavity. It may be that the anterior surface region of the first lens member and the posterior surface region of the third lens member do not include a diffractive optical element.

Thus, alternatively, each of the surfaces defining the diffractive optical elements may be located on the second lens member. Providing a second lens member that includes each of the diffractive optical elements may increase the degree to which the second lens member can be misaligned relative to the first and third lens members during manufacture without adversely affecting optical performance, and may thereby make manufacture easier and/or reduce the risk of lens assemblies being rejected during manufacture.

The contact lens assembly may be configured such that, in use, the anterior surface of a lens member is positioned further from the surface of the eye than the posterior surface of the lens member. Thus, it may be that when used to describe a surface “anterior” refers to a surface facing away from the eye when the contact lens assembly is in use on an eye. Similarly, it may be that when used to describe a surface “posterior” refers to a surface facing toward the eye when the contact lens assembly is in use on an eye.

A structured surface region may define a series of peaks and troughs. The peaks and troughs may have a regular or irregular periodic shape, which may comprise one or more of: substantially sinusoidal; square; triangular; sawtooth; or any combination thereof. It will be appreciated that a structured surface region may diffract light incident thereon. Thus, the structure surface region may define a diffractive optical element. It may be that that diffractive optical element is a diffraction grating, for example a diffraction grating with a periodicity tuned for a particular range of visible wavelengths.

It may be that the first diffractive optical element and the second diffractive optical element are located in the optical zone of the lens assembly. It may be that the first diffractive optical element is located such that, in use, light passes through the second diffractive optical element before reaching the first diffractive optical element. It may be that the first diffractive optical element and second diffractive optical element are both located on the optical axis of the lens assembly, for example with the second diffractive optical element in front of the first diffractive optical element. The first and second diffractive optical elements may be overlapping, for example coextensive and/or concentric. It may be that the contact lens assembly is configured such that, in use on the eye, light passes through the first and second liquid crystal cells before entering the eye.

The contact lens assembly may comprise one or more liquid crystal cells. It may be that each liquid crystal cell comprises one or more of: a first electrode, a first insulation layer, a first liquid crystal alignment layer, a liquid crystal layer, a second liquid crystal alignment layer, a second insulation layer and a second electrode. It may be that each liquid crystal cell comprises one or more of: a first electrode, a first insulation layer, a first liquid crystal alignment layer, a liquid crystal layer, a second liquid crystal alignment layer, a second insulation layer and a second electrode, in that order from the posterior to the anterior of the lens assembly.

It may be that the contact lens assembly comprises a first liquid crystal layer within the first cavity. It may be that the first liquid crystal layer forms part of a first liquid crystal cell. It may be that the contact lens assembly comprises a second liquid crystal layer within the second cavity. It may be that the second liquid crystal layer forms part of a second liquid crystal cell. The present disclosure may find particular application with contact lens assemblies including two or more liquid crystal cells.

It may be that the second lens member is substantially inflexible. In this context, substantially inflexible may be defined as sufficiently rigid for the second lens member to maintain a fixed position relative to the first and third lens members in use. It may be that the second lens member has substantially the same flexibility as the first lens member and/or the second lens member. It may be that the second lens member maintains its shape in use.

It may be that the second lens member is arranged to maintain a fixed spatial relationship with the first and/or third lens members. It may be that the second lens member is rigidly coupled to the first lens member and/or the second lens member.

It may be that the first cavity defines a first volume and the second cavity defines a second volume; and wherein in use the first and second volumes are substantially fixed. It may be that a volume of the first liquid crystal layer does not vary in use. It may be that a volume of the second liquid crystal layer does not vary in use.

It may be that the first and second liquid crystal layers have a predetermined thickness.

It may be that when the first liquid crystal layer is in a first state, the refractive index of the first diffractive optical element and the effective refractive index of the first liquid crystal layer are similar. It may be that, in the first state, the refractive indices of the first diffractive optical element and the first liquid crystal layer are similar such that the diffractive optical element does not diffract incident light. In this context, similar may be defined as being approximately the same, for example a difference in refractive index having a magnitude of not more than 0.03, for example not more than 0.02, for example not more than 0.01. Such a difference may be calculated at a wavelength of 450 nm. It may be that when the first liquid crystal layer is in a second state, the refractive index of the first diffractive optical element and the effective refractive index of the first liquid crystal layer are dissimilar. It may be that the refractive indices of the first diffractive optical element and the first liquid crystal layer are dissimilar such that the diffractive optical element diffracts incident light, for example such that the diffractive optical element contributes to the optical power of the lens. Likewise, it may be that when the second liquid crystal layer is in a first state (which may or may not be the same state as the first liquid crystal layer when in its first state), the refractive index of the second diffractive optical element and the effective refractive index of the second liquid crystal layer are similar and/or when the second liquid crystal layer is in a second state (which may or may not be the same state as the first liquid crystal layer when in its second state), the refractive index of the second diffractive optical element and the effective refractive index of the second liquid crystal layer are dissimilar such that the diffractive optical element diffracts incident light, for example such that the diffractive optical element contributes to the optical power of the lens. It may be that the first state is an unswitched state (i.e. with no or a low voltage applied to the liquid crystal cell). It may be that the second state is a switched state (i.e. with a voltage applied to the cell). Examples of such switchable liquid crystal cells are discussed in US 2023/0119885 the contents of which are incorporated herein by reference. For the avoidance of doubt, the effect refractive index of a liquid crystal layer is the refractive index of the liquid crystal for light normally incident on the contact lens assembly and the liquid crystal layer. The liquid crystal layer may be a cholesteric liquid crystal layer.

It may be that the effective refractive index of each diffractive optical element and/or the structured surface region defining said diffractive optical element, is dissimilar to the refractive index of the surface region of the lens member that is adjacent, for example surrounding, said structured surface region. It may be that each lens member having a structured anterior surface region has a uniform anterior surface region (being a surface region that does not define a diffractive optical element) adjacent, for example surrounding, the structured anterior surface region defining the diffractive optical element. Thus, the anterior surface of a lens member may comprise a structured region (the structured anterior surface region), and optionally a uniform region. Likewise, it may be that each lens member having a structured posterior surface region has a uniform posterior surface region (being a surface region that does not define a diffractive optical element) adjacent, for example surrounding, the structured posterior surface region defining the diffractive optical element. Thus, the posterior surface of a lens member may comprise a structured region (the structured posterior surface region), and optionally a uniform region. Thus, in the case that the structured surface regions are on the first and third lens members, it may be that the anterior and posterior surfaces of the second lens member are uniform in the region of the first and second cavities. Alternatively, in the case that each structured surface region is on the second lens member, it may be that the anterior surface of the first lens member and the posterior surface of the third lens member are uniform in the region of the first and second cavities.

It may be that the diameter of the second lens member is less than the diameter of the first and third lens members. It may be that the first and third lens members are in contact at an edge region of the contact lens assembly. It may be that the first and third lens members define a component cavity in which an electronics package may be received. It may be that the component cavity extends radially outwards from an outer edge of the second lens member. It may be that a posterior surface region of the third lens member, an anterior surface region of the first lens member, and an outer edge of the second lens member define a component cavity.

According to a second aspect of the disclosure, there is provided a method of constructing a contact lens assembly comprising first, second and/or third lens members. It may be that the first lens member comprises a first diffractive optical element in an anterior surface of the first lens member. It may be that the third lens member comprises a second diffractive optical element in a posterior surface of the third lens member. The method may comprise the step of forming a first diffractive optical element in an anterior surface of the first lens member and/or forming a second diffractive optical element in a posterior surface of the third lens member. The method may then comprise arranging the second lens member between the first and third lens members such that the structured anterior surface region of the first lens member and a posterior surface region of the second lens member together define a first cavity, and/or the structured posterior surface region of the third lens member and an anterior surface region of the second lens member together define a second cavity. It may be that the posterior and anterior surface regions of the second lens member (the surface regions of the second lens member that define the first and second cavities) do not include a structured surface region defining a diffractive optical element.

Alternatively, the second lens member may comprise a first diffractive optical element in a posterior surface of the second lens member and/or a second diffractive optical element in an anterior surface of the second lens member. The method may comprise the step of forming a first diffractive optical element in a posterior surface of the second lens member and/or forming a second diffractive optical element in an anterior surface of the second lens member. The method may then comprise arranging the second lens member between the first and third lens members such that the structured posterior surface region of the second lens member and an anterior surface region of the first lens member together define a first cavity, and/or the structured anterior surface region of the second lens member and a posterior surface region of the third lens member together define a second cavity. It may be that the anterior surface region of the first lens member and the posterior surface region of the third lens member (the surface regions of the first and third lens members that define the first and second cavities) do not include a structured surface region defining a diffractive optical element.

It may be that at least one of the steps of forming the first diffractive optical element and forming the second diffractive optical element comprises shaping and/or molding the posterior and/or anterior surface of the second lens member.

The step of forming a diffractive optical element may comprise molding a lens member such that the lens member includes a surface region defining a diffractive optical element.

The lens assembly of the second aspect may have any of the features described above with reference to the first aspect, and vice versa.

In a third aspect of the disclosure, there is provided a contact lens assembly, the lens assembly comprising: an anterior lens member and a posterior lens member. It may be that the contact lens assembly is configured such that when the contact lens assembly is in use on the eye of a user, the posterior lens member is closer to the surface of the eye than the anterior lens member. The contact lens assembly may further comprise an optical zone. The contact lens assembly may further comprise an adhesive zone in which the anterior and posterior lens members are bonded together. It may be that a region of an anterior surface of the posterior lens member and a region of a posterior surface of the anterior lens member form a seal that prevents the flow of fluid between the adhesive zone and the optical zone via said regions.

In this way, the risk of adhesive entering the optical zone may be reduced. Additionally, or alternatively, this is achieved without the need for additional components, by appropriately shaping the relevant surfaces of the lens members. The contact lens assembly may have any of the features described above in respect of the first aspect. Hereafter, the term “sealing regions” may be used to refer to the region of the anterior surface of the posterior lens member and the region of the posterior surface of the anterior lens member that form the seal.

It may be that there is no void between the sealing regions at the seal. It may be that the sealing regions contact, for example directly contact, each other to form the seal. Additionally or alternatively, it may be that there is a gap between the sealing regions at the seal but said gap is filled by one or more intervening layers such that there is no void between the sealing regions. Said one or more intervening layers may be a first and/or second electrode layer, and/or an insulating layer (for example between the first and second electrode layers). Said one or more intervening layers may form part of a liquid crystal cell. It may be that the gap between the sealing regions is less than 10 μm across the seal. Said one or more layers may be applied as coatings to one or both of the lens members.

The (first) adhesive zone may extend around a portion of, for example the majority of, for example substantially the whole of, the outer circumference of the optical zone of the lens assembly. Additionally or alternatively, the contact lens assembly may comprise a plurality of (first) adhesive zones, spaced apart circumferentially around the contact lens assembly, such that the adhesives zones together extend around a portion of, for example the majority of, for example substantially the whole of, the outer circumference of the optical zone of the lens assembly. It may be that, when viewed in plan from the front of the lens, the adhesive zone is annular and/or the or each adhesive zone forms a portion of an annulus. The contact lens assembly may comprise an adhesive layer which bonds the posterior and anterior lens members together in the adhesive zone(s). Additionally or alternatively, the adhesive may have changed the surface properties of the lens members such that the lens members are bonded together but a separate adhesive layer cannot be discerned.

The sealing regions and/or seal may extend around a portion of, for example the majority of, for example substantially the whole of, the outer circumference of the optical zone. Additionally or alternatively, the contact lens assembly may comprise a plurality of sealing regions and/or seals, spaced apart circumferentially around the contact lens assembly, such that the sealing regions/seals together extend around a portion of, for example the majority of, for example substantially the whole of, the outer circumference of the optical zone of the lens assembly. It may be that, when viewed in plan from the front of the lens, each sealing region/seal is annular and/or the or each sealing region/seal forms a portion of an annulus. The adhesive zone and the seal/sealing regions may be concentric, for example with the adhesive zone(s) located radially outside the seal(s)/sealing regions.

The lens assembly may comprise a component cavity, for example in which a component, for example an electronics package, is or may be located. The component cavity may be defined, at least in part, between the anterior and posterior lens members. The electronics package may comprise one or more electronic components, for example a battery or other power source and/or electronics circuitry. The electronics package may comprise control circuitry configured to change the state of a liquid crystal cell. The electronics package may be encapsulated within an encapsulation material. The electronics package and/or component cavity may be annular. The electronics package and/or component cavity may extend around a portion of, for example the majority of, for example substantially the whole of, the outer circumference of the optical zone of the lens assembly. It may be that the electronics package is bonded to the anterior and/or posterior lens members, of any further lens members, if present, for example using an adhesive. It may be that the adhesive zone(s), the seal(s), the sealing regions and the electronics package/component cavity are concentric, for example with the adhesive zone(s) located between the electronics package/component cavity and the seal(s).

The lens assembly may comprise a second adhesive zone(s), for example located radially outside the (first) adhesive zone and the electronics package/component cavity. The second adhesive zone may extend around a portion of, for example the majority of, for example substantially the whole of, the outer circumference of the electronics package and/or component cavity. Additionally or alternatively, the contact lens assembly may comprise a plurality of second adhesive zones, spaced apart circumferentially around the contact lens assembly, such that the adhesives zones together extend around a portion of, for example the majority of, for example substantially the whole of, the outer circumference of the first adhesive zone and the electronics package/component cavity. It may be that, when viewed in plan from the front of the lens, the second adhesive zone is annular and/or the or each second adhesive zone forms a portion of an annulus.

The optical zone encompasses the parts of the lens that have optical functionality in use. The lens and/or lens assembly may be configured such that the optic zone is positioned in front of the pupil of an eye when in use. The optical zone may encompass a portion, or the entirety of, a central region of the lens assembly. The optical zone may be circular and/or oval when viewed in plan from the front of the lens.

The contact lens assembly may comprise a medial adhesive reservoir. It may be that the medial adhesive reservoir is a cavity formed at least in part, for example defined, between the posterior and anterior lens members. It may be that the medial adhesive reservoir(s) is located (radially, i.e. in a radial direction) between the adhesive zone and the seal/sealing regions such that adhesive applied to the adhesive zone can flow into the medial adhesive reservoir.

In this way, the medial adhesive reservoir may serve to contain any adhesive that overflows from the adhesive zone towards the optical zone. This may reduce the risk of excess adhesive reaching the contact region and/or leaking through the seal.

As for the adhesive zone and seal/sealing regions, the lens assembly may comprise a single medial adhesive reservoir, or a plurality of such reservoirs spaced apart circumferentially around the outer circumference of the optical zone. The medial adhesive reservoir (or reservoirs if more than one is present) may extend around a portion of, for example the majority of, for example substantially the whole of, the outer circumference of the optical zone and/or may extend around a portion of, for example the majority of, for example substantially the whole of, the inner circumference of the adhesive zone.

It may be that one of the anterior surface of the posterior lens member and the posterior surface of the anterior lens member defines a recess, the recess being located radially between the adhesive zone and the seal. It may be that the other of the anterior surface of the posterior lens member and the posterior surface of the anterior lens member defines a protuberance. It may be that protuberance is received within the recess to thereby constrain, for example prevent movement, for example radial movement, of the posterior lens member relative to the anterior lens member. Thus, the recess and the protuberance may maintain the posterior and anterior lens members in alignment. It may be that the recess is an annular channel formed in the surface of the lens member. It may be that the protuberance is annular. Thus the protuberance may be a locating ring, for example, integrally formed in the lens member. It may be that the radially inward side of the protuberance abuts the radially inward side of the recess around the majority of, for example substantially the whole of, the inner circumference of the recess. In this way, the protuberance and recess may have a geometrically simple form while holding the lens members in alignment.

In other aspects of the present disclosure, there is a described a contact lens assembly comprising first, second and third lens members. It will be appreciated that a seal as described in the present application may be used in such a contact lens assembly. For example, it may be that the posterior lens member is a first lens member and the anterior lens member is a second lens member. Alternatively, it may be that the posterior lens member is a second lens member and the anterior lens member is a third lens member. Or, it may be that the contact lens assembly comprises two seals in accordance with the present aspect. It may be that the contact lens assembly comprises a first seal formed between the first lens member and the second lens member, and a second seal formed between the second lens member and the third lens member. In that context, it will be appreciated that other features as described herein, e.g. an adhesive zone, a medial adhesive reservoir, a seal/sealing regions, a recess, a protuberance, a component cavity, a distal adhesive reservoir and/or a liquid crystal reservoir may be defined by or between; the anterior surface of the first lens member and the posterior surface of the second lens members, or the anterior surface of the second lens member and the posterior surface of the third lens member.

Alternatively, it may be that the contact lens assembly comprises only two lens members in the optic zone; an anterior lens member and a posterior lens member, the seal being formed therebetween. Alternatively, it may be that the contact lens assembly comprise only two lens members; an anterior lens member and a posterior lens member, the seal being formed therebetween.

It may be that the medial adhesive cavity is defined at least in part by the recess and the protuberance. For example, the radial extent of the recess may be defined between the recess and the protuberance. It may be that the medial adhesive cavity is defined between the (radially) outermost side of the recess and the (radially) outermost side of the protuberance. It may be that the radially outermost side is the outer side of the protuberance or recess at any given circumferential location. It may be that the radial extent of the protuberance is less than the radial extent of the recess such that the protuberance can be received within, but does not fill, the recess. In this way, a medial adhesive reservoir may be provided without any additional components.

It may be that the contact lens assembly comprises a distal adhesive reservoir. It may be that the distal adhesive reservoir is a cavity formed, at least in part, for example defined, between the two lens members. It may be that the distal adhesive reservoir is formed between the anterior and posterior lens members. In the case that the contact lens assembly comprises first, second and third lens members, it may be that the distal adhesive reservoir is formed between the first and third lens members. It may be the distal adhesive reservoir is wholly defined by said lens members. It may be that the distal adhesive reservoir is located between an adhesive zone, for example the first and/or second adhesive zone, and an outer edge of the lens assembly such that adhesive applied to the adhesive zone can flow into the distal adhesive reservoir. In this way, the distal adhesive reservoir may serve to contain any adhesive that overflows from the adhesive zone towards the outer edge of the lens assembly. This may reduce or avoid adhesive flowing out of the lens assembly during and/or after manufacture.

It may be that the distal adhesive reservoir is annular, or a part of an annulus, when viewed in plan. As for the adhesive zone and contact region, the lens assembly may comprise a single distal adhesive reservoir, or a plurality of such reservoirs spaced apart circumferentially around the outer circumference of the adhesive zone. The distal adhesive reservoir(s) may extend around a portion of, for example the majority of, for example substantially the whole of, the outer circumference of the adhesive zone.

The outer edge of the anterior lens member may abut the anterior surface of the posterior lens member, for example in the region of the edge of the lens assembly. The outer edge of the anterior lens member may abut the posterior lens member such that radial movement of the anterior lens member relative to the posterior lens member is constrained, for example prevented. The posterior lens member may comprise a rim, for example a region of increased thickness caused by a change in curvature of the anterior surface of the posterior lens member. The anterior lens member may abut the rim of the posterior lens member. The distal adhesive reservoir(s) may be defined at least in part by the outer edge of the anterior lens member and the anterior surface of the posterior lens member, for example the rim of the posterior lens member.

Where the contact lens assembly comprises first, second and third lens members, it may be that the outer edge of the third lens member abuts the anterior surface of the first lens member, for example in the region of the edge of the lens assembly. It may be that the outer edge of the third lens member abuts the first lens member such that radial movement of the first lens member relative to the third lens member is constrained, for example prevented. The first lens member may comprise a rim, for example a region of increased thickness caused by a change in curvature of the anterior surface of the first lens member. The third lens member may abut the rim of the first lens member. The distal adhesive reservoir(s) may be defined at least in part by the outer edge of the third lens member and the anterior surface of the first lens member, for example the rim of the first lens member.

It may be that the second lens member comprises a rim, for example a region of increased thickness caused by a change in curvature of the anterior or posterior surface of the second lens member. The rim of the second lens member may be located in an edge region of the second lens member. It may that the first lens member or third lens member abuts the rim of the second lens member such that movement of the second lens member relative to said first or third lens member is constrained.

It may be that the contact lens assembly further comprises a flow passage extending between the or each distal adhesive reservoir and an outer surface of the lens assembly. A flow passage may be a closed channel connecting the distal adhesive reservoir with the outer surface of the lens assembly. In this way, excess adhesive can flow along the channel to the outer surface where it can then be removed via machining or other post-processing steps. A flow passage may be formed in the posterior lens member, the first lens member (if present), second lens member (if present) and/or third lens member (if present). The flow passage may extend from the anterior surface of the lens member to the posterior surface of the lens member (the posterior surface of the lens member may be an outer surface of the lens assembly). The outer surface may form part of the outer edge of the lens assembly.

It may be that the lens assembly further comprises a liquid crystal layer. The liquid crystal layer may be located in the optical zone. The liquid crystal layer may be concentric with the optical zone.

The lens assembly may comprise a liquid crystal reservoir. It may be that the liquid crystal reservoir is a cavity formed, at least in part, for example defined, between the posterior and anterior lens members. The liquid crystal reservoir may be located (radially) between the liquid crystal layer and the contact region, for example such that liquid crystal from the liquid crystal layer can flow into the liquid crystal reservoir. The liquid crystal reservoir may be located (radially) between the optical zone and the contact region, for example such that liquid crystal from the optical zone can flow into the liquid crystal reservoir. Thus, the liquid crystal reservoir may contain liquid crystal that overflows from the optical zone/liquid crystal layer, and thereby reduce the risk of adhesive and liquid crystal coming into contact with one another. It may be that the liquid crystal reservoir is annular, or a part of an annulus, when viewed in plan. As for the adhesive zone and contact region, the lens assembly may comprise a single liquid crystal reservoir, or a plurality of such reservoirs spaced apart circumferentially around the outer circumference of the optical zone/liquid crystal layer. The liquid crystal reservoir(s) may extend around a portion of, for example the majority of, for example substantially the whole of, the outer circumference of the optical zone/liquid crystal layer. The liquid crystal reservoir(s) may extend around a portion of, for example the majority of, for example substantially the whole of, the inner circumference of the protuberance/recess (if present), and/or the contact region.

It may be that, if present, the adhesive zone, contact region, optical zone, medial adhesive reservoir(s), recess, protuberance, distal adhesive reservoir(s), outer edge, flow passage(s), liquid crystal layer, liquid crystal reservoir and/or outer edge of the lens assembly are rotationally symmetric around a reference axis aligned with the centre of the optical zone and orthogonal to an anterior surface of the first lens member at the centre of the optical zone.

In a fourth aspect of the disclosure, there is provided a method of constructing a contact lens assembly. The method may comprise applying adhesive to a region of an anterior surface of a posterior lens member and/or a region of a posterior surface of an anterior lens member. The method may then comprise bringing the anterior surface of the posterior lens member together with the posterior surface of the anterior lens member thereby (i) causing adhesive to move from the region(s) to which it has been applied towards the optical zone and/or (ii) forming a seal between the anterior surface of the posterior lens member and the posterior surface of the anterior lens member that impedes or prevents said adhesive that has moved reaching the optical zone.

It may be that adhesive is retained by a medial adhesive reservoir located between the region(s) to which that adhesive has been applied and the contact region.

It may be that one of the anterior surface of the posterior lens member and the posterior surface of the anterior lens member defines a recess, the recess being located between the adhesive zone and the contact region, and the other of the anterior surface of the posterior lens member and the anterior surface of the second lens member defines a protuberance, wherein the protuberance is received within the recess when the first lens member and second member are brought together, and thereby constrain movement of the posterior lens member relative to the anterior lens member.

It may be that bringing the posterior lens member together with the anterior lens member also causes adhesive to move from the region(s) to which it has been applied towards an outer edge of the lens assembly; and wherein adhesive is retained by a medial adhesive reservoir located between the region(s) to which that adhesive has been applied and the outer edge.

It may be that bringing the first lens member together with the second lens member also causes liquid crystal to move from the optical zone towards the region(s) to which the adhesive has been applied; and wherein liquid crystal is retained by a liquid crystal reservoir located between the optical zone and the contact region.

In a fifth aspect of the disclosure, there is provided a contact lens assembly comprising a first lens member, a second lens member, a third lens member, electronic circuitry, a first electrode layer and/or a second electrode layer. It may be that the second lens member is located between the first and third lens members. It may be that the first electrode layer is located between the first and second lens members. It may be that the second electrode layer is located between the second and third lens members. It may be that the first electrode layer and the second electrode layer are connected to the electronic circuitry such that in use, the first and second electrode layers have the same polarity. For example, it may be that both layers are positive electrodes, or both layers are negative electrodes.

Thus, the contact lens assembly may comprise electrodes of the same polarity either side of the second lens member. This may reduce the likelihood of a short circuit and/or electrical interference, in contrast with an arrangement with electrodes of opposite polarity located either side of the lens member.

The first electrode layer may be a layer applied to, for example directly onto, the posterior surface of the second lens member. The second electrode layer may be a layer applied to, for example directly onto, the anterior surface of the second lens member. An electrode layer may comprise an electrically conductive material, such as copper and/or a semiconductor. An electrode layer may be applied via sputtering. The first and second electrode layers may be substantially continuous, for example extending from one side of the second lens member to the other around the outer edge of the lens member. Alternatively, there may be a gap between the first and second electrode layers at the outer edge of the second lens member.

The contact lens assembly may comprise a third electrode layer located between an anterior surface of the first lens member and the first electrode layer, and/or a fourth electrode layer located between a posterior surface of the third lens member and the second electrode layer. The third electrode layer may be a layer applied to, for example directly onto, the anterior surface of the first lens member. The fourth electrode layer may be a layer applied to, for example directly onto, the posterior surface of the third lens member.

It may be that the third and fourth electrode layers are connected to the electronic circuitry such that in use, the third and fourth electrode layers have the same polarity. For example it may be that both layers are positive electrodes, or both layers are negative electrodes. It may be that the polarity of the third and fourth electrodes is opposite to the polarity of the first and second electrodes.

In this way, two distinct electrical circuits may be formed within the lens assembly: one between the first and third electrode layers; and one between the second and fourth electrode layers.

It may be that the first and third electrode layers form part of a first liquid crystal cell. It may be that the second and fourth electrode layers form part of a second liquid crystal cell. Thus, the lens assembly may comprise two liquid crystal cells as described above. It may be that the first liquid crystal cell and second liquid crystal cell are both located on the optical axis of the lens assembly, for example with the second liquid crystal cell in front of the first liquid crystal cell. The first and second liquid crystal cells may be overlapping, for example coextensive and/or concentric. The contact lens assembly and/or any contact lens of which it forms a part may be arranged such that, in use on the eye, light passes through the first and second liquid crystal cells before entering the eye.

The electronic circuitry may form part of an electronics package, for example encapsulated within encapsulation material. It may be that the electronics package extends between, at least part of, the second lens member and the first lens member, for example such that the first and third electrode layers are separated by the electronics package in at least one region. It may be that the electronics package extends between, at least part of, the second lens member and the third lens member, for example such that the first and third electrode layers are separated by the electronics package in at least one region.

It may be that a portion of the second lens member extends between an upper portion and a lower portion of the electronics package. It may be that the radially inward edge of the electronics package includes a recess, for example a circumferentially extending recess in which a portion of the second lens member, for example an outer edge region of the second lens member, is received.

The contact lens assembly may comprise a first electrical contact via which the electronics package is connected to the first electrode layer. The contact lens assembly may comprise a second electrical contact via which the electronics package is connected to the second electrode layer. The first and second electrical contacts may be on opposite sides of the second lens member, for example on opposite sides of the portion of the second lens member received within the recess of the electronics package. The first and second electrical contacts may be located on opposing surfaces of the electronics packages, for example such that the first and second electrical contacts are opposite each other. The contact lens assembly may comprise a third electrical contact via which the electronics package is connected to the third electrode layer. The contact lens assembly may comprise a fourth electrical contact via which the electronics package is connected to the fourth electrode layer. The third and fourth electrical contacts may be located on the posterior and anterior surfaces of the electronics package respectively.

In a sixth aspect of the disclosure, there is provided a method of constructing a contact lens assembly comprising first, second and third lens members and/or electronic circuitry. It may be that the method comprises applying a first electrode layer to the posterior surface of the second lens member and/or applying a second electrode layer to the anterior surface of the second lens member. It may be that the method then comprises placing the second lens member between the first and third lens members. It may be that the method comprises connecting the first electrode layer and the second electrode layer to the electronic circuitry such that, in use, the first and second electrode layers have the same polarity.

It may be that the method comprises applying a third electrode layer to the anterior surface of the first lens member and/or applying a fourth electrode layer to the posterior surface of the third lens member. It may be that the method comprises connecting the third electrode layer and the fourth electrode layer to the electronic circuitry such that, in use, the third and fourth electrode layers have the same polarity.

It may be that an electrode layer is applied by sputtering.

In a further aspect of the disclosure there is provided a contact lens comprising the contact lens assembly of any other aspect.

The contact lens assembly may form the whole or a portion of a contact lens. As used herein, “contact lens” means an ophthalmic lens that can be placed on the eye of a person. It will be appreciated that such a contact lens will provide clinically acceptable on-eye movement and not bind to the eye or eyes of a person. The contact lens may be a corneal lens (e.g. a lens that rests on the cornea of the eye), or a scleral lens (e.g. a lens that rests on the sclera of the eye). The contact lens may be a soft contact lens, such as a hydrogel contact lens or a silicone hydrogel contact lens. The contact lens may be a rigid gas permeable contact lens.

It may be that each lens member comprises a hydrogel material, or a silicone hydrogel material, or a mixture thereof. It may be that the first lens member, the second lens member and/or the third lens member comprises, consists or consists essentially of a hydrogel material, a silicone hydrogel material or a mixture thereof. It may be that at least two of the first lens member, the second lens member and the third lens member comprises, consists or consists essentially of the same material. It may be that the second lens member comprises the same material as the first and/or third lens members. It may be that at least two of the first, second and third lens members have the same rigidity. It may be that the second lens member has the same rigidity as the first and/or third lens members. It may be that at least two of the first, second and third lens members have the same refractive index. It may be that each lens member has substantially the same refractive index. It may be that the first lens member, the second lens member and the third lens member have substantially the same refractive index. It may be that at least two of the first lens member, the second lens member and the third lens member have substantially the same modulus of elasticity. It may be that at least two of the first lens member, the second lens member and the third lens member are made of a material with the same modulus of elasticity.

It may be that the second lens member has a centre thickness of between 20 μm and 150 μm. It may be that the first, second and/or third lens member has a centre thickness of between 20 μm and 150 μm. It may be that a thickness of the contact lens assembly is between 60 μm and 450 μm, optionally between 100 to 400 μm, for example 300 μm. It may be that the second lens member has substantially the same centre thickness as the first and/or third lens member.

The contact lens may be circular in shape. The contact lens may have a diameter from 4 mm to 22 mm inclusive, for example from 10 mm to 22 mm inclusive. The optic zone may be circular in shape. The optic zone may have a diameter of from 2 mm to 10 mm inclusive. In some embodiments, the contact lens has a diameter from 13 mm to 16 mm inclusive, for example a diameter of 14 mm, and the optic zone has a diameter from 5 mm to 8 mm inclusive, for example 6 mm. The contact lens may be rotationally symmetric in the optic zone.

In a further aspect of the invention there is provided a contact lens blister package containing a contact lens assembly or contact lens in accordance with any other aspect. The blister package may contain a contact lens packaging solution, for example the lens/lens assembly may be provided in such a solution.

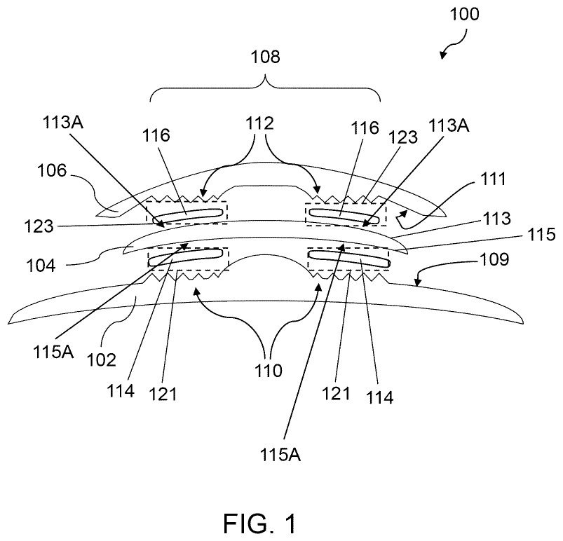

FIG. 1 is an exploded cross-sectional view of a contact lens assembly 100 according to an example embodiment of the present disclosure. The contact lens assembly 100 comprises a first lens member 102, a second lens member 104 and a third lens member 106. The second lens member 104 is located between the first lens member 102 and the third lens member 106. The first lens member 102 is located at the posterior side of the lens assembly 100 so that, in use, the first lens member 102 is positioned adjacent to the eye. In the centre of lens assembly 100 is an optical zone 108. In use, the optical zone 108 aligns with the pupil of the eye of the wearer. The first lens member 102 comprises an anterior surface 109 comprising a structured anterior surface region 110. The structured anterior surface region 110 is annular when viewed in plan. The structured anterior surface region 110 is a series of peaks and troughs extending radially across the anterior surface 109 of the first lens member 102. The peaks and troughs form a diffractive optical element to diffract light incident thereon.

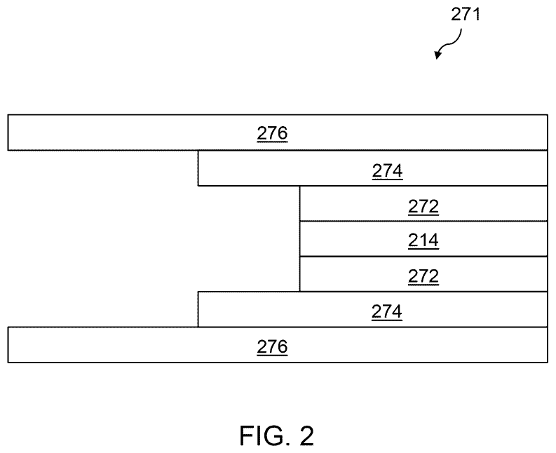

The third lens member 106 is located at the anterior side of the lens assembly 100, such that, in use, the third lens member 106 is positioned further from the eye than the first lens member 102. The third lens member 106 comprises a posterior surface 111 comprising a structured posterior surface region 112. The structured posterior surface region 112 is annular when viewed in plan. The structured posterior surface region 112 is a series of peaks and troughs extending radially across the posterior surface 111 of the third lens member 106. The peaks and troughs form a diffractive optical element to diffract light incident thereon. The structured posterior surface region 112 is located above structured anterior surface region 110 in FIG. 1 such that, in use, light passes through structured posterior surface region 112 before reaching structured anterior surface region 110, and light passes through structured posterior surface region 112 and structured anterior surface region 110 before reaching the eye of a user. The second lens member 104 is between the first and third lens members 102, 106, and has an anterior surface 113 and a posterior surface 115, located on opposite sides of the second lens member 104. A first liquid crystal layer 114 is located within a first cavity (not shown in FIG. 1) defined between the structured anterior surface region 110 of the first lens member 102 and a region 115A of the posterior surface 115 of the second lens member 104. Similarly, a second liquid crystal layer 116 is located within a second cavity (not shown in FIG. 1) defined between the structured posterior surface region 112 of the third lens member 106 and a region 113A of the anterior surface 113 of the second lens member 104. While not shown in the cross-section, both the first and second liquid crystal layers 114, 116 extend around the lens assembly in a substantially annular shape in plan view. The first liquid crystal layer 114 forms part of a first liquid crystal cell 121 (shown with a dashed lines in FIG. 1). Similarly, the second liquid crystal layer 116 form part of a second liquid crystal cell 123 (shown with a dashed lines in FIG. 1). An example structure of such liquid crystal cells is discussed in more detail with reference to FIG. 2, below.

In some embodiments, the second lens member 104 may have a spherical anterior surface 113 and/or a spherical posterior surface 115 in the optical zone 108. Because neither structured surface region defining the diffractive optical elements is located on second lens member 104, embodiments in accordance with the present example may allow for a greater degree of misalignment between the second lens member and the first and third lens members. This may make manufacture easier and/or reduce the rate at which contact lens assemblies are rejected during manufacture.

In the embodiments described above, neither structured surface region defining the peaks and troughs of a diffractive optical element is formed in the second lens member, which has uniform anterior and posterior surfaces. In alternative embodiments, both of the structured surface regions defining the peaks and troughs of first and second diffractive optical elements are formed in the second lens member, with one structured surface region being on the anterior surface of the second lens member, and the other structured surface region being on the posterior surface of the second lens member. The first and second cavities are then defined between the structured surface region and corresponding portions of the anterior surface of the first lens member and the posterior surface of the third lens member, respectively. Those surface portions of the first and third lens members are substantially uniform. Otherwise, such embodiments may be as described above and below. Having both structured surface regions defining the diffractive optical elements located on second lens member 104, may allow for a greater degree of misalignment between the second lens member and the first and third lens members. This may make manufacture easier and/or reduce the rate at which contact lens assemblies are rejected during manufacture.

Each liquid crystal layer 114, 116 can be switched between at least two states: a first state in which the effective refractive index of the liquid crystal layer matches the refractive index of the corresponding diffractive optical element such that the diffractive optical element does not diffract light; and a second state in which the refractive indices of the liquid crystal layer and the corresponding diffractive optical element are dissimilar such that the diffractive optical element diffracts light. In this way, the diffractive optical power of the lens assembly 100 can be controlled via electronic circuitry.

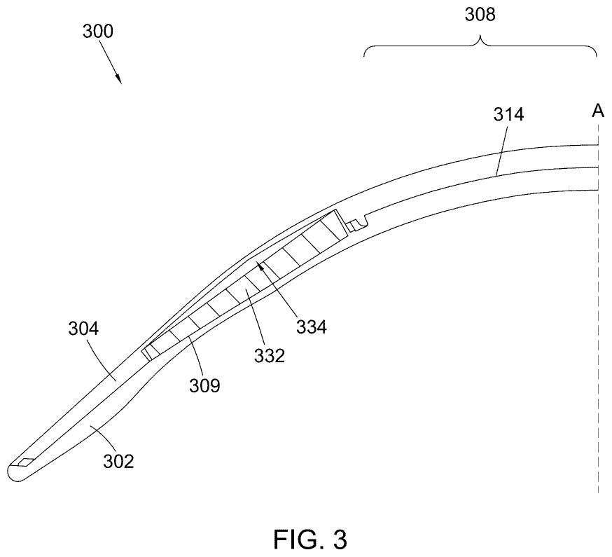

FIG. 2 is a schematic cross-sectional view of an example liquid crystal cell 271, for example for use in the contact lens assembly of FIG. 1. It will be appreciated that the relative thickness of the layers may vary significantly from what is shown in FIG. 2 which is highly schematic. The liquid crystal cell 271 comprises a liquid crystal layer 214. Either side of the liquid crystal layer 214 (i.e. above and below the horizontally extending liquid crystal layer 214 in FIG. 2) is a liquid crystal alignment layer 272. An insulation layer 274 is located on the outer side of each liquid crystal alignment layer 272. An electrode layer 276 is located on the outer side of each insulation layer 274. In use, the polarity of the two electrode layers 276 differs, such that an electronic circuit can be completed between the liquid crystal layer 214 and controlling electronic circuitry (e.g. an electronics package as discussed further with reference to FIG. 3). The electrode layers 276 and insulation layers 274 are shown as having a greater lateral extent that the other layers in FIG. 2. This is to reflect the fact that these layers may extend out from the cavity in which the liquid crystal layer 272 is located, to connected the liquid crystal layer 272 to electronic circuitry located elsewhere in the contact lens assembly.

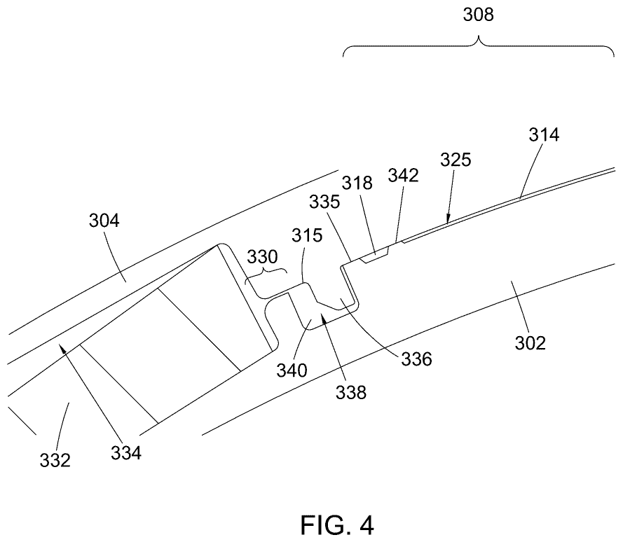

With reference to FIG. 3 and FIG. 4, there is shown a cross-sectional view of part of a contact lens assembly 300 according to an embodiment of the present disclosure. Contact lens assembly 300 is symmetric about a central vertical axis A (denoted with a dashed line in FIG. 3). The lens assembly comprises a posterior lens member 302 at the posterior side of the lens assembly 300 (i.e. arranged so that in use the posterior lens member 302 is positioned adjacent to the eye). An anterior lens member 304 is bonded to the anterior surface 309 of the posterior lens member 302. In the centre of lens assembly 300 is an optical zone 308. In use, the optical zone 308 aligns with the pupil of the eye of the wearer. Peripheral to the optical zone 308, is a first adhesive zone 330 (which is annular when viewed in plan) in which the first and second lens members 302, 304 are bonded together with adhesive. In some embodiments, the first adhesive zone extends around the majority of, for example the whole of the outer circumference of the optical zone 308. An electronics package 332 occupies a component cavity 334 defined between the posterior and anterior lens members 302, 304. In some embodiments, component cavity 334 and electronics package 332 are annular when viewed in plan and extend around the majority of, for example the whole of the outer circumference of the optical zone 308. The contact lens assembly 300 also comprises a layer of liquid crystal 314 in a cavity 325 defined between posterior and anterior lens members 302, 304. The layer of liquid crystal 314 and cavity 325 are located in the optical zone 308. In some embodiments, the liquid crystal 314 and cavity 325 are circular when viewed in plan. The layer of liquid crystal 314 forms part of a liquid crystal cell (not shown in FIG. 3 and FIG. 4) as described above with reference to FIG. 2. Electronics package 332 comprises a power source and/or electronic circuitry (not shown) for controlling the function of the liquid crystal cell and is electrically connected to the liquid crystal cell via electrode layers.

FIG. 4 shows a close up of the contact lens assembly of FIG. 3, in the region of the outer edge of the optical zone 308 and the inner edge of the electronics package 332/component cavity 334. In this region, the anterior surface 309 of the posterior lens member 302 and the posterior surface 315 of the anterior lens member 304 form a seal 335 that prevents the flow of fluid between the optical zone 308 and the first adhesive zone 330. In the embodiment of FIG. 4, the seal 335 is formed by the anterior surface 309 and posterior surface 315 coming closer together, such that the surfaces are abutting and there is no void between the anterior surface 309 and posterior surface 315. Electrode layers and/or insulating layers are located in between the anterior surface 309 and posterior surface 315 which extend across the seal 335 to electrically connected electronics package 332 and liquid crystal layer 314. It will be appreciated that such layers are very thin in comparison to the thickness of the lens members, such that even when such layers are present and the anterior surface 309 and posterior surface 315 are not in direct contact, those surfaces are nevertheless very close together such that they appear to be touching in FIG. 4. In yet further embodiments, it may be that anterior surface 309 and posterior surface 315 are in direct contact with each other to form the seal 335. The contact lens assembly 300 also comprises a protuberance 336 in the form of a locating ring which projects from the posterior surface 315 of the anterior lens member 304. The locating ring (protuberance 336) sits within a recess 338 in the form of a channel formed in the anterior surface 309 of the posterior lens member 302. The recess 338 is annular when viewed in plan. It will be appreciated that the recess and/or protuberance may take various forms provided those forms are complementary in terms of shape. A portion of the recess 338 that is unoccupied by the protuberance 336 forms a medial adhesive reservoir 340. The medial adhesive reservoir 340 is located on the radially outer side of the protuberance 336. Located radially between the seal 335 and the cavity 325 is a liquid crystal reservoir 318 being a channel formed in the anterior surface 309 of the posterior lens member 302. A further seal 342 is formed between the anterior surface 309 and posterior surface 315 at a region located radially between the cavity 325 and liquid crystal reservoir 318.

In use, seal 335 and/or further seal 342 prevent the flow of adhesive and/or liquid crystal between the first adhesive zone 330 and the optical zone 308. In this way, the risk of optical defects in the lens is reduced. Excess adhesive may accumulate in medial adhesive reservoir 340 reducing the amount of adhesive that reaches seal 335, and thereby further reducing the risk of adhesive reaching the optical zone. Likewise, excess liquid crystal may accumulate in liquid crystal reservoir 318 reducing the amount of liquid crystal that reaches seal 335, and thereby further reducing the risk of adhesive reaching the adhesive zone. Protuberance 336 and recess 338 may assist in maintaining the anterior and posterior lens members in alignment and/or provide a further obstacle to adhesive and/or liquid crystal flowing between the first adhesive zone 330 and the optical zone 308.

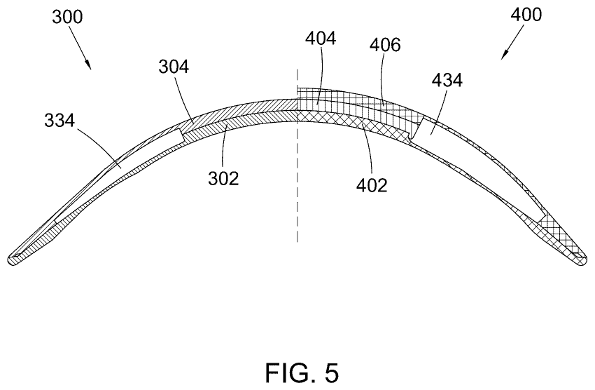

The left-hand side of FIG. 5 shows a cross-sectional view of the left hand side of the lens assembly 300 of FIGS. 3 and 4. It will be appreciate that said lens assembly is rotationally symmetric. The lens assembly 300 comprises a single liquid crystal cell and may therefore be referred to as a single stack assembly. The right-hand side of FIG. 5 shows a cross-section view of the right-hand side of a contact lens assembly 400 being a variation of the contact lens assembly 100 of FIG. 1. The contact lens assembly 400 comprises a first lens member 402 arranged at the posterior side of the assembly, a third lens member 406 at the anterior side of the assembly and a second lens member 404 arranged between the first and third lens members 402, 406. As described above with reference to FIG. 1, a first liquid crystal cell (not shown) is arranged between the first lens member 402 and second lens member 404, and a second liquid crystal cell (not shown) is arranged between the second lens member 404 and third lens member 406. Due to the presence of the two liquid crystal cells, one atop the other, the contact lens assembly 400 may be referred to as a double stack assembly. Only those aspects of the contact lens assembly 400 not described with respect to the contact lens assembly 100 will be described here. A component cavity 434 is defined between the first 402 and third 406 lens members, and extends radially outward from the outer edge of the second lens member 404 which has a diameter less than the diameter of the first and third lens members 402, 406. In some embodiments, the component cavity 434 includes an electronics package as described above with reference to FIGS. 3 and 4. The double-stack lens assembly 400 of FIG. 5 may have any of the sealing/reservoir features described above with reference to FIGS. 3 and 4, in order to prevent liquid crystal and/or adhesive moving between the adhesive and optical zones.

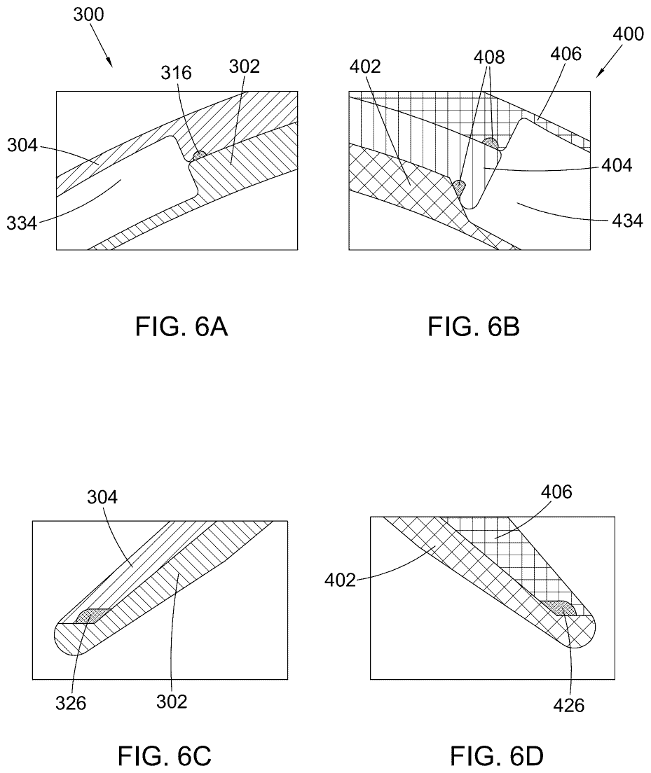

FIG. 6A is a cross-sectional view showing a region of the lens assembly 300 which includes the innermost edge of the component cavity 334. FIG. 6B is a cross-sectional view showing a region of the lens assembly 400 which includes the innermost edge of the component cavity 434. The contact lens assembly 300 comprises a single medial adhesive reservoir 316 in the form of a recess defined between the posterior 302 and anterior 304 lens members, and located radially between the optical zone 308 and the component cavity 334. The contact lens assembly 400 comprises two medial adhesive reservoirs 408: a first medial adhesive reservoir 408 is defined between the first 402 and second 404 lens members; and a second medial adhesive reservoir 408 is defined between the second 404 and third 406 lens members. The second lens member 404 comprises a rim 450 extending rearwards at the outer edge of the lens member. The anterior surface 113 of the first lens member 402 abuts the rim 450 to constrain movement of the second lens member 404 relative to the first lens member 402.

FIG. 6C shows the left-hand outer edge region of the contact lens assembly 300. FIG. 6D shows the right-hand outer edge region of the contact lens assembly 400. Since the second lens member 404 does not extend all the way to the perimeter of the lens assembly, both contact lens assemblies have a single distal adhesive reservoir. In the contact lens assembly 300, the distal adhesive reservoir 326 is defined between the anterior 302 and posterior 304 lens members. In the contact lens assembly 400, the distal adhesive reservoir 426 is defined between the first 402 and third 406 lens members.

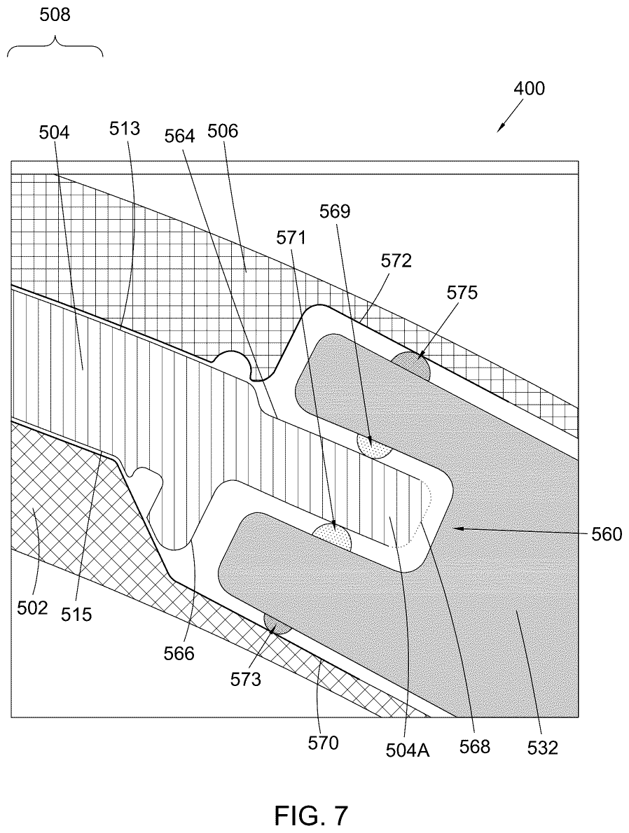

FIG. 7 is a cross-sectional view of part of a contact lens assembly 500 according to an embodiment of the present disclosure. Only those elements of the contact lens assembly 500 not described in relation to the contact lens assembly 100 and the contact lens assembly 400 will be described here. Similar elements as between the contact lens assembly 100 and the contact lens assembly 500 are denoted with reference numbers from FIG. 1 and FIG. 2 prefaced with a 5 rather than a 1 or a 2 (i.e. the first lens member 102 of FIG. 1 is referred to as first lens member 502 in FIG. 7). In FIG. 7 the electronics package 532 includes an indent 560 in its innermost edge, into which a portion 504A of the second lens member 504 extends. First and second electrode layers 564, 566 (for example applied via sputtering) cover regions of the posterior 515 and anterior 513 surfaces of the second lens member 504 respectively. At the end of the portion 504A, a gap 568 between the first and second electrode layers 564, 566 is shown in broken lines in FIG. 7 to indicate the limitations of the sputtering process in applying a continuous electrode layer to the surfaces of the second lens member 504. A third electrode layer 570 covers the anterior surface of the first lens member 502, and a fourth electrode layer 572 covers the posterior surface of the third lens member 506. The electrode layers are connected to the electronics package 532 via discrete contacts. In use, the first and second electrode layers 564, 566 have the same polarity, as do the third and fourth electrode layers 570, 572. In this way, two electrode pairs are provided, suitable for use in a double stack lens assembly with two liquid crystal cells (not shown). A first contact 569 connects the first electrode layer 564 to the electronics package 532, while a second contact 571 connects the second electrode layer 566 to the electronics package 532. A third contact 573 connects the third electrode layer 570 to the electronics package 532, while a fourth contact 575 connects the fourth electrode layer 572 with the electronics package 532. Because electrodes of the same polarity are provided on the second lens member 504, the risk of a short circuit may be reduced.

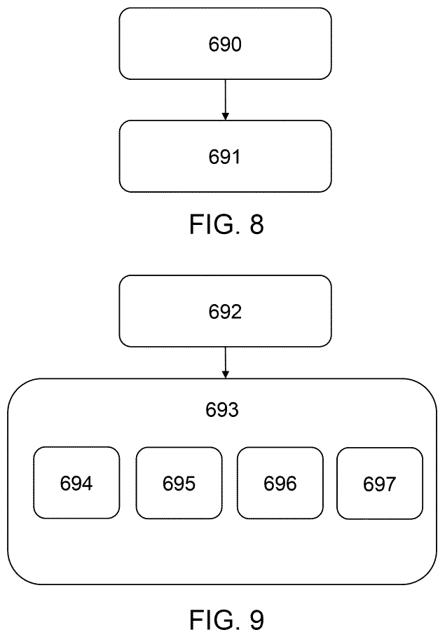

FIG. 8 shows the steps of an example method of constructing a contact lens assembly, for example a lens assembly as described above in relation to FIG. 1, according to the present disclosure. The method comprises a step 690 of forming (i) a first diffractive optical element in an anterior surface of a first lens member and (ii) a second diffractive optical element in a posterior surface of a third lens member. Then, the method comprises arranging 691 the second lens member between the first and third lens members such that the structured anterior surface region of the first lens member and a posterior surface region of the second lens member together define a first cavity, and the structured posterior surface region of the third lens member and an anterior surface region of the second lens member together define a second cavity.

FIG. 9 shows the steps of an example method of constructing a contact lens assembly, for example a lens assembly as described above in relation to FIG. 3 and FIG. 4, or FIG. 5, according to the present disclosure. There method comprises applying 692 adhesive to a region of an anterior surface of a posterior lens member and/or a region of a posterior surface of an anterior lens member. Then, the method comprises bringing 693 the posterior lens member together with the anterior lens member. The step of bringing 693 the two lens members together includes movement 694 of adhesive from the region(s) to which it has been applied towards the optical zone and forming 695 a seal between the anterior surface of the posterior lens member and the posterior surface of the anterior lens member that impedes or prevents said adhesive reaching the optical zone. Optionally, the step of bringing 693 the two lens members together also includes adhesive being retained 696 by a medial adhesive reservoir located between the region(s) to which that adhesive has been applied and the seal and/or receiving 697 a protuberance within a recess to constrain movement of the first lens member relative to the second lens member.

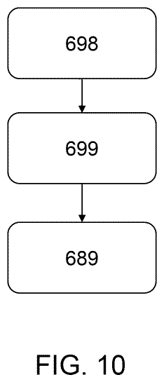

FIG. 10 shows the steps of an example method of constructing a contact lens assembly, for example a lens assembly as described above in relation to FIG. 7, according to the present disclosure. The method comprises applying 698 a first electrode layer to a posterior surface of a second lens member and a second electrode layer to an anterior surface of the second lens member. Then, the method comprises placing 699 the second lens member between the first and third lens members, and connecting 689 the first electrode layer and the second electrode layer to the electronic circuitry such that in use, the first and second electrode layers have the same polarity.

Aspects and embodiments of the invention will now be described by way of numbered clauses.

Clause 1: A contact lens assembly comprising: a first lens member having a structured anterior surface region defining a first diffractive optical element, a second lens member, and a third lens member having a structured posterior surface region defining a second diffractive optical element; wherein the second lens member is located between the first and third lens members such that the structured anterior surface region of the first lens member and a posterior surface region of the second lens member together define a first cavity, and the structured posterior surface region of the third lens member and an anterior surface region of the second lens member together define a second cavity; and wherein the posterior and anterior surface regions of the second lens member do not include a diffractive optical element.

Clause 2: A contact lens assembly comprising: a first lens member, a second lens member having a structured posterior surface region defining a first diffractive optical element and a structured anterior surface region defining a second diffractive optical element, and a third lens member; wherein the second lens member is located between the first and third lens members such that the structured posterior surface region of the second lens member and an anterior surface region of the first lens member together define a first cavity, and the structured anterior surface region of the second lens member and a posterior surface region of the third lens member together define a second cavity; and wherein the anterior surface region of the first lens member and the posterior surface region of the third lens member do not include a diffractive optical element.

Clause 3: The contact lens assembly according to clause 1 or clause 2, further comprising a first liquid crystal layer within the first cavity, and a second liquid crystal layer within the second cavity, the first liquid crystal layer forming part of a first liquid crystal cell and the second liquid crystal layer forming part of a second liquid crystal cell.

Clause 4: The contact lens assembly according to clause 3, wherein in a first state the refractive index of the first diffractive optical element and the effective refractive index of the first liquid crystal layer are similar such that the first diffractive optical element does not diffract incident light, and/or, in a first state the refractive index of the second diffractive optical element and the effective refractive index of the second liquid crystal layer are similar such that the second diffractive optical element does not diffract incident light.

Clause 5: The contact lens assembly according to clause 4, wherein in a second state the refractive indices of the first diffractive optical element and the first liquid crystal layer are dissimilar such that the first diffractive optical element diffracts incident light, and/or the refractive indices of the second diffractive optical element and the second liquid crystal layer are dissimilar such that the second diffractive optical element diffracts incident light.

Clause 6: A method of constructing a contact lens assembly comprising first, second and third lens members, the method comprising the steps of: forming a first diffractive optical element in an anterior surface of the first lens member and forming a second diffractive optical element in a posterior surface of the third lens member; and then arranging the second lens member between the first and third lens members such that the structured anterior surface region of the first lens member and a posterior surface region of the second lens member together define a first cavity, and the structured posterior surface region of the third lens member and an anterior surface region of the second lens member together define a second cavity; and wherein the posterior and anterior surface regions of the second lens member do not include a structured surface region defining a diffractive optical element.

Clause 7: A method of constructing a contact lens assembly comprising first, second and third lens members, the method comprising the steps of: forming a first diffractive optical element in a posterior surface of the second lens member and forming a second diffractive optical element in an anterior surface of the second lens member; and then arranging the second lens member between the first and third lens members such that the structured posterior surface region of the second lens member and an anterior surface region of the first lens member together define a first cavity, and the structured anterior surface region of the second lens member and a posterior surface region of the third lens member together define a second cavity; and wherein the posterior surface region of the third lens member and the anterior surface region of the first lens member do not include a structured surface region defining a diffractive optical element.

Clause 8: A contact lens assembly, the lens assembly comprising: an anterior lens member and a posterior lens member, arranged such that in use, the posterior lens member is closer to the eye of a user than the anterior lens member; an optical zone and an adhesive zone in which the anterior and posterior lens members are bonded together; and wherein a region of an anterior surface of the posterior lens member and a region of a posterior surface of the anterior lens member form a seal that prevents the flow of fluid between the adhesive zone and the optical zone via said regions.

Clause 9: The contact lens assembly according to clause 8, further comprising a medial adhesive reservoir being a cavity formed at least in part between the anterior and posterior lens members and located between the adhesive zone and the seal such that adhesive applied to the adhesive zone can flow into the medial adhesive reservoir.

Clause 10: The contact lens assembly according to clause 8 or clause 9, wherein one of the anterior surface of the posterior lens member and the posterior surface of the anterior lens member defines a recess, the recess being located radially between the adhesive zone and the seal, and the other of the anterior surface of the posterior lens member and the posterior surface of the anterior lens member defines a protuberance, wherein the protuberance is received within the recess to constrain movement of the posterior lens member relative to the anterior lens member.

Clause 11: The contact lens assembly according to clause 10 when dependent on clause 9, wherein the medial adhesive reservoir is defined at least in part by the recess and the protuberance, for example between the radially outermost side of the recess and the radially outermost side of the protuberance.

Clause 12: The contact lens assembly according to any of clauses 8 to 11, further comprising a distal adhesive reservoir being a cavity formed at least in part between the posterior and anterior lens members and located between an adhesive zone and an outer edge of the lens assembly such that adhesive applied to the adhesive zone can flow into the distal adhesive reservoir.

Clause 13: The contact lens assembly according to clause 12, further comprising a flow passage extending between the distal adhesive reservoir and an outer surface of the lens assembly.

Clause 14: The contact lens assembly according to any of clauses 8 to 13, wherein the lens assembly further comprises a liquid crystal reservoir, the liquid crystal reservoir being a cavity formed at least in part between the posterior and anterior lens members, the liquid crystal reservoir being located between the optical zone and the seal such that liquid crystal from the optical zone can flow into the liquid crystal reservoir.

Clause 15: A method of constructing a contact lens assembly comprising a posterior lens member, an anterior lens member and an optical zone, the method comprising; applying adhesive to a region of an anterior surface of the posterior lens member and/or a region of a posterior surface of the anterior lens member; and then bringing the posterior lens member together with the anterior lens member thereby (i) causing adhesive to move from the region(s) to which it has been applied towards the optical zone and (ii) forming a seal between the anterior surface of the posterior lens member and the posterior surface of the anterior lens member that impedes or prevents said adhesive that has moved reaching the optical zone.

Clause 16: A method according to clause 15, wherein adhesive is retained by a medial adhesive reservoir located between the region(s) to which that adhesive has been applied and the seal.

Clause 17: A method according to clause 15 or clause 16, wherein one of the anterior surface of the posterior lens member and the posterior surface of the anterior lens member defines a recess, the recess being located between the adhesive zone and the seal, and the other of the anterior surface of the posterior lens member and the posterior surface of the anterior lens member defines a protuberance, wherein the protuberance is received within the recess when the posterior lens member and anterior lens member are brought together, and thereby constrains movement of the posterior lens member relative to the anterior lens member.

Clause 18: A method according to any of clauses 15 to 17, wherein bringing the posterior lens member together with the anterior lens member also causes adhesive to move from the region(s) to which it has been applied towards an outer edge of the lens assembly; and wherein adhesive is retained by a medial adhesive reservoir located between the region(s) to which that adhesive has been applied and the outer edge.

Clause 19: A method according to any of clauses 15 to 18, wherein bringing the posterior lens member together with the anterior lens member also causes liquid crystal to move from the optical zone towards the region(s) to which the adhesive has been applied; and wherein liquid crystal is retained by a liquid crystal reservoir located between the optical zone and the seal.

Clause 20: A contact lens assembly comprising a first lens member, a second lens member, a third lens member, electronic circuitry, a first electrode layer and a second electrode layer; and wherein the second lens member is located between the first and third lens members, the first electrode layer is located between the first and second lens members, and the second electrode layer is located between the second and third lens members; and the first electrode layer and the second electrode layer are connected to the electronic circuitry such that in use, the first and second electrode layers have the same polarity.

Clause 21: The contact lens assembly according to clause 20, further comprising a third electrode layer located between an anterior surface of the first lens member and the first electrode layer, and/or a fourth electrode layer located between a posterior surface of the third lens member and the second electrode layer.

Clause 22: The contact lens assembly according to clause 21, wherein the third and fourth electrode layers are connected to the electronic circuitry such that in use, the third and fourth electrode layers have the same polarity, being an opposite polarity to the polarity of the first and second electrode layers.

Clause 23: The contact lens assembly according to clause 21 or clause 22, wherein the first and third electrode layers form part of a first liquid crystal cell and the second and fourth electrode layers form part of a second liquid crystal cell.

Clause 24: A method of constructing a contact lens assembly comprising first, second and third lens members and electronic circuitry, the method comprising: applying a first electrode layer to the posterior surface of the second lens member; applying a second electrode layer to the anterior surface of the second lens member; placing the second lens member between the first and third lens members; and connecting the first electrode layer and the second electrode layer to the electronic circuitry such that in use, the first and second electrode layers have the same polarity.

Clause 25: The method according to clause 24, wherein the first and second electrode layers are applied to the second lens member by sputtering.

Clause 26: A contact lens comprising the contact lens assembly according to any one of clauses 1 to 5, 8 to 14 and 20 to 23.

Clause 27: A contact lens according to clause 26, wherein the contact lens is a silicone hydrogel contact lens.

Clause 28: A blister package containing a contact lens according to clause 26 or 27.

Clause 29: A contact lens assembly, the lens assembly comprising: an anterior lens member and a posterior lens member, arranged such that in use, the posterior lens member is closer to the eye of a user than the anterior lens member; an optical zone and an adhesive zone in which the anterior and posterior lens members are bonded together; and wherein a region of an anterior surface of the posterior lens member and a region of a posterior surface of the anterior lens member form a seal that prevents the flow of fluid between the adhesive zone and the optical zone via said regions; wherein the lens assembly further comprises a liquid crystal reservoir, the liquid crystal reservoir being a cavity formed at least in part between the posterior and anterior lens members, the liquid crystal reservoir being located between the optical zone and the seal such that liquid crystal from the optical zone can flow into the liquid crystal reservoir.

Clause 30: The contact lens assembly according to clause 29, further comprising a medial adhesive reservoir being a cavity formed at least in part between the anterior and posterior lens members and located between the adhesive zone and the seal such that adhesive applied to the adhesive zone can flow into the medial adhesive reservoir.

Clause 31: The contact lens assembly according to clause 29 or clause 30, wherein one of the anterior surface of the posterior lens member and the posterior surface of the anterior lens member defines a recess, the recess being located radially between the adhesive zone and the seal, and the other of the anterior surface of the posterior lens member and the posterior surface of the anterior lens member defines a protuberance, wherein the protuberance is received within the recess to constrain movement of the posterior lens member relative to the anterior lens member.

Clause 32: The contact lens assembly according to clause 31 when dependent on clause 30, wherein the medial adhesive reservoir is defined at least in part by the recess and the protuberance, for example between the radially outermost side of the recess and the radially outermost side of the protuberance.

Clause 33: The contact lens assembly according to any of clauses 29 to 32, further comprising a distal adhesive reservoir being a cavity formed at least in part between the posterior and anterior lens members and located between an adhesive zone and an outer edge of the lens assembly such that adhesive applied to the adhesive zone can flow into the distal adhesive reservoir.

Clause 34: The contact lens assembly according to clause 33, further comprising a flow passage extending between the distal adhesive reservoir and an outer surface of the lens assembly.

Clause 35: The contact lens assembly according to clause 34, wherein the flow passage is configured to allow excess adhesive to reach the outer surface.

Clause 36: A method of constructing a contact lens assembly comprising a posterior lens member, an anterior lens member and an optical zone, the method comprising; applying adhesive to a region of an anterior surface of the posterior lens member and/or a region of a posterior surface of the anterior lens member; and then bringing the posterior lens member together with the anterior lens member thereby (i) causing adhesive to move from the region(s) to which it has been applied towards the optical zone and (ii) forming a seal between the anterior surface of the posterior lens member and the posterior surface of the anterior lens member that impedes or prevents said adhesive that has moved reaching the optical zone; wherein bringing the posterior lens member together with the anterior lens member also causes liquid crystal to move from the optical zone towards the region(s) to which the adhesive has been applied; and wherein liquid crystal is retained by a liquid crystal reservoir located between the optical zone and the seal.

Clause 37: A method according to clause 36, wherein adhesive is retained by a medial adhesive reservoir located between the region(s) to which that adhesive has been applied and the seal.

Clause 38: A method according to clause 36 or clause 37, wherein one of the anterior surface of the posterior lens member and the posterior surface of the anterior lens member defines a recess, the recess being located between the adhesive zone and the seal, and the other of the anterior surface of the posterior lens member and the posterior surface of the anterior lens member defines a protuberance, wherein the protuberance is received within the recess when the posterior lens member and anterior lens member are brought together, and thereby constrains movement of the posterior lens member relative to the anterior lens member.

Clause 39: A method according to any of clauses 36 to 38, wherein bringing the posterior lens member together with the anterior lens member also causes adhesive to move from the region(s) to which it has been applied towards an outer edge of the lens assembly; and wherein adhesive is retained by a medial adhesive reservoir located between the region(s) to which that adhesive has been applied and the outer edge.

Clause 40: A contact lens comprising the contact lens assembly according to any one of clauses 29 to 35.

Clause 41: A contact lens according to clause 40, wherein the contact lens is a silicone hydrogel contact lens.

Clause 42: A blister package containing a contact lens according to clause 40 or 41.

Clause 43: A contact lens assembly comprising a first lens member, a second lens member, a third lens member, electronic circuitry, a first electrode layer and a second electrode layer; and wherein the second lens member is located between the first and third lens members, the first electrode layer is located between the first and second lens members, and the second electrode layer is located between the second and third lens members; and the first electrode layer and the second electrode layer are connected to the electronic circuitry such that in use, the first and second electrode layers have the same polarity.

Clause 44: The contact lens assembly according to clause 43, further comprising a third electrode layer located between an anterior surface of the first lens member and the first electrode layer, and/or a fourth electrode layer located between a posterior surface of the third lens member and the second electrode layer.

Clause 45: The contact lens assembly according to clause 44, wherein the third and fourth electrode layers are connected to the electronic circuitry such that in use, the third and fourth electrode layers have the same polarity, being an opposite polarity to the polarity of the first and second electrode layers.

Clause 46: The contact lens assembly according to clause 44 or clause 45, wherein the first and third electrode layers form part of a first liquid crystal cell and the second and fourth electrode layers form part of a second liquid crystal cell.

Clause 47: The contact lens assembly according to any of clauses 43 to 46, wherein the first and second electrode layers are substantially continuous.

Clause 48: The contact lens assembly according to any of clauses 43 to 47, wherein the first and second electrode layers extend from one side of the second lens member to the other around an outer edge of the second lens member.

Clause 49: The contact lens assembly according to any of clauses 43 to 47, further comprising a gap between the first and second electrode layers at an outer edge of the second lens member.

Clause 50: The contact lens assembly according to any of clauses 43 to 49, wherein the electronic circuitry forms part of an electronics package, wherein a portion of the second lens member extends between an upper portion and a lower portion of the electronics package.

Clause 51: The contact lens assembly according to clause 50, wherein a radially inward edge of the electronics package includes a recess in which a portion of the second lens member is received.

Clause 52: The contact lens assembly according to clause 51, wherein the recess circumferentially extends around the radially inward edge of the electronics package, and an outer edge region of the second lens member is received within the recess.

Clause 53: A method of constructing a contact lens assembly comprising first, second and third lens members and electronic circuitry, the method comprising: applying a first electrode layer to the posterior surface of the second lens member; applying a second electrode layer to the anterior surface of the second lens member; placing the second lens member between the first and third lens members; and connecting the first electrode layer and the second electrode layer to the electronic circuitry such that in use, the first and second electrode layers have the same polarity.

Clause 54: The method according to clause 53, wherein the first and second electrode layers are applied to the second lens member by sputtering.

Clause 55: A contact lens comprising the contact lens assembly according to any one of clauses 43 to 52.

Clause 56: A contact lens according to clause 55, wherein the contact lens is a silicone hydrogel contact lens.

Clause 57: A blister package containing a contact lens according to clause 55 or 56.

At least some of the embodiments disclosed herein facilitate improved manufacturability of lenses including diffractive optical elements and/or liquid crystal cells, and/or facilitate easier and/or more cost effective manufacture of such lenses, and/or facilitate a reduction in the number of lenses rejected during manufacture, and/or facilitate a reduction in risk of defects developing in such lenses in use.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. A contact lens assembly comprising:
a first lens member,
a second lens member having a structured posterior surface region defining a first diffractive optical element and a structured anterior surface region defining a second diffractive optical element, and
a third lens member;
wherein the second lens member is located between the first and third lens members such that the structured posterior surface region of the second lens member and an anterior surface region of the first lens member together define a first cavity, and the structured anterior surface region of the second lens member and a posterior surface region of the third lens member together define a second cavity; and
wherein the anterior surface region of the first lens member and the posterior surface region of the third lens member do not include a diffractive optical element.

2. The contact lens assembly according to claim 1, wherein at least one of the structured posterior surface region and the structured anterior surface region defines a series of peaks and troughs.

3. The contact lens assembly according to claim 1, further comprising a first liquid crystal layer within the first cavity, and a second liquid crystal layer within the second cavity, the first liquid crystal layer forming part of a first liquid crystal cell and the second liquid crystal layer forming part of a second liquid crystal cell.

4. The contact lens assembly according to claim 3, wherein in a first state the refractive index of the first diffractive optical element and the effective refractive index of the first liquid crystal layer are similar such that the first diffractive optical element does not diffract incident light, and/or, in a first state the refractive index of the second diffractive optical element and the effective refractive index of the second liquid crystal layer are similar such that the second diffractive optical element does not diffract incident light.

5. The contact lens assembly according to claim 4, wherein in a second state the refractive indices of the first diffractive optical element and the first liquid crystal layer are dissimilar such that the first diffractive optical element diffracts incident light, and/or the refractive indices of the second diffractive optical element and the second liquid crystal layer are dissimilar such that the second diffractive optical element diffracts incident light.

6. A method of constructing a contact lens assembly comprising first, second and third lens members, the method comprising the steps of:
forming a first diffractive optical element in a posterior surface of the second lens member and forming a second diffractive optical element in an anterior surface of the second lens member; and then
arranging the second lens member between the first and third lens members such that the structured posterior surface region of the second lens member and an anterior surface region of the first lens member together define a first cavity, and the structured anterior surface region of the second lens member and a posterior surface region of the third lens member together define a second cavity; and
wherein the posterior surface region of the third lens member and the anterior surface region of the first lens member do not include a structured surface region defining a diffractive optical element.

7. The method according to claim 6, wherein at least one of the steps of forming the first diffractive optical element and forming the second diffractive element comprise shaping and/or moulding the posterior and/or anterior surface of the second lens member.

8. A contact lens comprising the contact lens assembly according to claim 1.

9. A contact lens according to claim 8, wherein the contact lens is a silicone hydrogel contact lens.

10. A blister package containing a contact lens according to claim 8.
